(19) United States
(12) Patent Application Publication
(10) Pub. No.: US 2005/0154669 A1
(43) Pub. Date: Jul. 14, 2005

(54) Carbon credit marketing system

(76) Inventor: Foy Streetman, Chickasha, OK (US)

Correspondence Address: A PATENT LAWYER CORP, PC;R WILLIAM GRAHAM, 3340 ROSEWOOD LN, OKLAHOMA CITY, OK, 73120, US

(21) Appl. No.: 10/753,291

(22) Filed: Jan. 8, 2004

(51) Int. Cl. G06F 17/60

(52) U.S. Cl. 705/38

(57) ABSTRACT

A carbon credit system includes a server computer operably connected to an Internet and having an operating system and a memory operably associated therewith, carbon credit software operably disposed in the memory and accessible through said operating system, wherein a carbon credit product or carbon credit service can be purchased through said carbon credit software and which carries a predetermined number of carbon credits and said purchase causes one of a good and service certificate bearing a carbon credit consumer symbol (“CCCP”) to be sent to said purchaser. A method of promoting carbon reduction is provided.

### BACKGROUND OF THE INVENTION

### FIELD OF THE INVENTION

This invention relates to a carbon credit application. More particularly, the invention relates to a method of carbon credit marketing and one which in part employs a web-based system.

There is a growing international concern over emission of “greenhouse” gases, such as carbon dioxide and methane, found in trace quantities in the atmosphere, which absorb infrared energy and prevent such energy from leaving the atmosphere. Increasing levels of greenhouse gases in the atmosphere may therefore contribute to an increase in average global temperatures, resulting in adverse climate changes otherwise known as global warming.

Emission of organic-based fuels accounts for 99% of total CO₂ emissions in the United States. Other countries around the world are also a major contributing factor to this end. In an attempt to solve the problem, entities are exploring ways to reduce the rate at which greenhouse gases are discharged into the atmosphere and ways to increase the rate these gases are cleansed from the atmosphere.

The Kyoto Protocol to the United Nations Framework Convention on Climate Change (UNFCCC), also known as the third session of the conference of the parties, or COP3, was negotiated in Kyoto in December 1997. Under the Protocol, the parties agreed to assigned amounts of “aggregate anthropogenic carbon dioxide equivalent emissions of greenhouse gases” over the period 2008 to 2012 (Protocol, Art. 3). Pursuant to Article 1, each party is challenged to promote sustainable development in achieving its quantified emission limitation. Policies and measures in furtherance thereof include: enhancement of energy efficiency in relevant sectors of the national economy; protection and enhancement of sinks and reservoirs of greenhouse gases and promotion of sustainable forest management practices, afforestation, deforestation and reforestation; promotion of sustainable forms of agriculture in light of climate change considerations; research, promotion, development and increased use of, new and renewable forms of energy, of carbon dioxide sequestration technologies and of advanced innovative environmentally sound technologies; progressive reduction or phasing out of market imperfections, fiscal incentives, tax and duty exemptions and subsidies of all greenhouse gas emitting sectors that run counter to the objective of the convention and applications of market instruments, e.g. (see generally, Protocol Art. 1(1) (a) (i)-(viii)).

Industrial nations are challenged to find ways to cut heat trapping emissions from burning fossils fuels that are believed to cause global warming by an average of 5.2% below 1990 levels through the period 2008 to 2012. Accordingly, carbon reducing plants provide a potential solution.

Photosynthetic organisms comprise a mechanism for cleansing or removing greenhouse gases from the atmosphere. Using light energy from the sun, carbon from the air in the form of carbon dioxide and water in the soil, green leaves make sugar in a reaction called photosynthesis. Plant growth is a natural process which produces organic matter by removing carbon compounds from the atmosphere. The amount of carbon sequestered in some woody plants is difficult to accurately measure in the living plant without destroying the plant. Trees in tropical and boreal forests have branches and limbs of varying lengths, diameters and are irregularly spaced and shaped. Woody plants sequester a large part of their carbon above ground. Grassy & herbaceous plants reach physiological maturity much sooner than woody plants and therefore can begin to sequester maximum amounts of carbon. In as little as sixty days from germination, annual grassy and herbaceous plants are sequestering maximum amounts of CO₂. This carbon sequestration is subject to limiting factors from intentional or unintentional fire, disease, decay, storms and insects.

One fact remains despite these known limiting factors, forests and grassy and herbaceous plants absorb million tons of carbon each year, and if properly maintained, can counterbalance carbon based emissions. A program has been implemented to trade carbon credits. These credits could be banked or traded among entities in order to reduce the levels of greenhouse gas emissions. A source of such carbon credits could emanate from growth green plants and reforestation.

While the theory of using carbon credits is a potential solution, there is a need for a creative way to implement and market such a solution to the problem. Therefore, there remains a need to provide a solution which is viably implemented to promote green plant growth and reforestation.

### SUMMARY OF THE INVENTION

It is an object to provide a method of marketing Rainforest credits to foster carbon credit acquisition.

It is an object to provide a web-based marketing carbon credit system.

It is another object to reduce carbon emissions in the environment.

It is yet another object to facilitate trading of carbon credits.

It is still another object to aid in reforestation and planting grassy and herbaceous land.

It is another object to expedite education of carbon credit awareness.

It is further another object of the invention to provide a method for facilitating carbon sequestration.

The carbon credit marketing system of the present invention enables a consumer to pay for the amount of greenhouse gases each produces as a result of each consumer's consumption of goods and services which effect emission of such gases. This is accomplished though the purchase and sale of Rainforest credits and/or carbon credits which in turn correlate to a carbon credit value assigned to a producer or user. The present invention is believed to present a vehicle to successfully implement a marketing process by which all consumers will be able to purchase products having a green carbon credit consumer symbol (“CCCP”), for example and can be referred to as a Rainforest Credit, through the system of the instant invention.

Accordingly, the invention in one embodiment includes a web-based server computer operably connected to the Internet and has an operating system and a memory operably associated therewith. Further, carbon credit software is operably associated with the memory and accessible through the operating system, wherein a carbon credit product or carbon credit service can be purchased through the carbon credit software and which carries a predetermined number of carbon credits and the purchase causes one of a good and a service certificate bearing a carbon credit consumer symbol (“CCCP”) to be sent to the purchaser.

The carbon credit software enables associating a number of carbon credits with at least one of a carbon credit producer and carbon credit user in a database in the memory. The system can include a calculator for determining a number of carbon credits for a predetermined good or service. The carbon credit calculator enables the consumer to determine the amount of greenhouse gases produced/consumed each year based on the good and/or service.

The carbon credit software enables creation of a client account in the memory and enables maintaining carbon credit balance in the account and enables access of multiple clients, each client having a carbon credit account. The carbon credit software provides for securely creating and accessing the client account.

The carbon credit software enables a client accessing the carbon credit software to purchase a carbon credit, and to sell a carbon credit, to list one of an offer to sell the carbon credit producing item and an offer to purchase the carbon credit using item. The carbon credit software can initiate a carbon reduction process as a result of the purchase a carbon credit. The carbon credit software enables a trade of carbon credits between the clients.

In another embodiment, a carbon credit system includes a web-based server computer operably connected to an Internet and having an operating system and a memory operably associated therewith, carbon credit software operably associated with the memory and accessible through the operating system. The carbon credit software enables creation of a client account in the memory and for maintaining carbon credits in the account wherein the carbon credit software enables associating purchased carbon credits and storing the carbon credits in the account. A carbon credit consumer symbol (“CCCP”) bearing product or carbon credit consumer symbol (“CCCP”) bearing service can be registered in a database of the memory with a predetermined product or service specific code. Upon a purchase of the carbon credit consumer symbol (“CCCP”) product or service occurring external to the carbon credit software, the carbon credit software permits a purchaser to enter the code and be credited a predetermined amount of carbon credits associated with the purchased good or service into his/her account.

A method of the invention provides for the steps of employing a predetermined carbon credit symbol (CCCP) and associating the CCCP symbol with a particular source of a good and a service, wherein each good and service provided by the source carries with it media bearing the CCCP symbol and a predetermined carbon credit value. The CCCP symbol is predetermined by the source as is the carbon credit value for each good/service.

Other objects and advantages will be apparent upon reading the description and viewing the drawings hereinafter.

### BRIEF DESCRIPTION OF THE DRAWING

In the detailed description which follows, reference is to be made to the drawing comprised of the following figures:

FIG. 1 is a schematic of the invention.

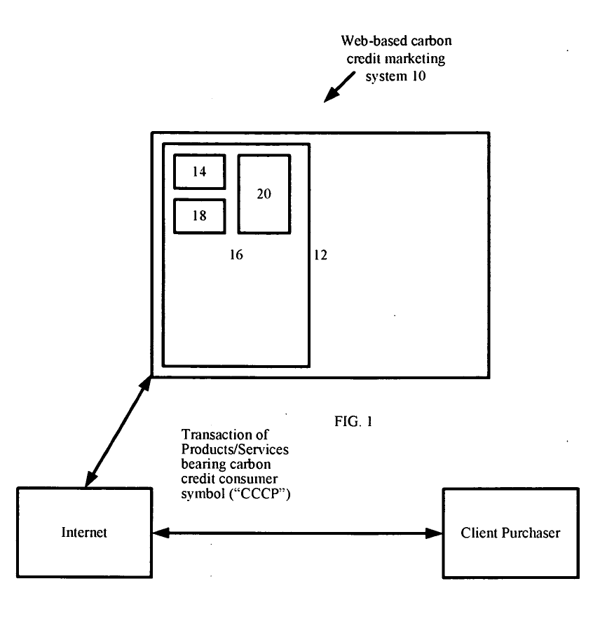

FIG. 2 depicts a tag showing an embodiment of CCCP symbol and credit value.

FIG. 3 illustrates a diagram of a cause and effect through use of the invention.

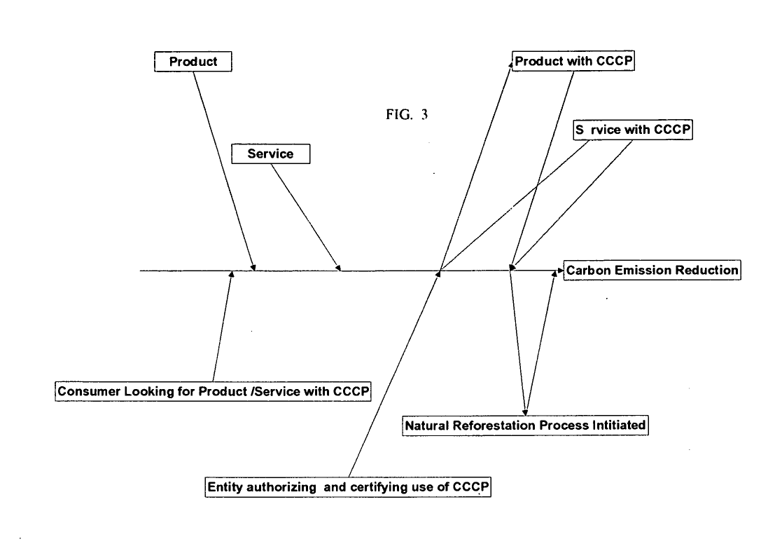

### DETAILED DESCRIPTION OF THE PREFERRED EMBODIMENTS

A marketing system can be employed with the instant invention which fosters acceptance of a carbon credit system. This is done in part by enabling a marketing system 10 of the invention wherein a web site can be employed in the system 10 which can be used to sell a product or a service to consumers in exchange for Rainforest Credits or carbon credits, wherein Rainforest Credits are predetermined to equate to an amount of carbon credits, without such product or service necessarily being tied to a particular carbon credit use or production value.

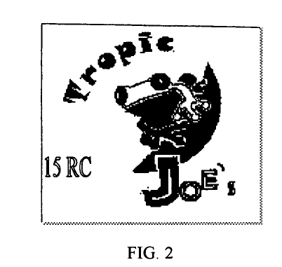

In other words, a “feel good” item in the form of a product or service can be sold carrying with it a predetermined carbon credit value exemplified with the Rainforest Credit (RC) value as seen in FIG. 2, for example, which is related to the planting of a tree, for example. The feel good product which the purchaser receives can be, for example, a T-shirt with a particular logo carrying a tag or mark identifying a carbon credit consumer symbol (“CCCP”), in FIG. 2 shown to be “Tropic Joe's symbol with a tree frog”, indicating that 15 RC's ( i.e., a predetermined number of carbon credit(s) based upon a standard which is predetermined) have been purchased. The carbon credit(s) can then be used by the purchaser towards other purchases or required carbon credit uses. Similarly, a Rainforest credit sponsorship service can be purchased through the carbon credit software 18 of the invention, e.g., sponsoring a youth group to take a trip to aid in natural reforestation, which is another aspect of the invention.

By natural reforestation, the instant invention predetermines that a given tree has a certain period of its initial growth and life span in which provides maximum carbon absorption. For example, the first ten years of its life, after which its carbon absorption utility diminishes. The present invention provides a marketing system wherein the CCCP symbol is only used in association with goods and services which subscribe to the attachment and assignment of carbon credits through natural reforestation. Natural reforestation would provide that these carbon absorption resources be periodically changed out to provide the maximum benefit to the environment as well as the economy. For example, the initially planted trees can be harvested after a period of maximum carbon absorption life and at point where the harvested tree can also provide a useful source of raw material to the economy.

The purchaser receives a feel good item via the system 10 with the CCCP symbol to show its sponsorship as well as gain Rainforest carbon credits to the purchaser's account. The purchase of these CCCP goods or services indicates that the purchaser initiated a carbon reduction process through natural reforestation as a result of the purchase the good/service. Each good and service provided by through or associated with a common CCCP issuing source, which can be a foundation or entity promoting reforestation, carries with it media bearing the CCCP symbol and a predetermined carbon credit value. The CCCP symbol is predetermined by the common source as is the carbon credit value for each good/service.

These purchased CCCP goods or services, in turn, carbon credits, can be used in an effort to sequester greenhouse gases, for example, an inventory of a geographic area capable of such sequestration, e.g., hectors of land, can be used for planting trees by the foundation. To understand the functionality of how the CCCP purchases can be effective, one needs to understand the effect of each product/service on emission. Assuming a good/service emits X lbs. of CO₂ per unit used; Y number of carbon credits can be calculated based on known output of a particular forestation or grassy/herbaceous land hector at a given dollar value Z $/lb.

Consequently, a formula can be derived:

$$\frac{( X good / service requires lbs cc ' s / unit ) }{( Z land type size yields number lbs cc ' s / \$ )} = Y carbon credits @ \$ / unit cost .$$

A cost value can be created with respect to the given good/service and assessed to the same. Thus, it can be learned that each product/service can bear a carbon credit value. The instant invention, aids in promoting a self help toward cleaning up the environment while getting some tangible and intangible value from the same.

Referring now to the drawings, the carbon credit system of the present invention is generally designated by the numeral 10. The carbon credit system 10 includes a web-based server computer 12 operably connected to an Internet and has an operating system 14 and a memory 16 operably associated therewith. Carbon credit software 18 is operably disposed in the memory 14 and accessible through the operating system 14 and is equipped to display a web site portal though which transactions can take place.

The carbon credit software 18 enables associating a number of carbon credits with at least one of a carbon credit producer and carbon credit user in a database 20 in the memory 16, wherein a carbon credit product or a service which is purchased carries a predetermined number of carbon credits which a purchaser can store in an account. The carbon credit software 18 preferably includes a calculator for determining a number of carbon credits for each particular predetermined good or service. Preferably, the product or service can include a predetermined carbon credit value for use in the system 10 and provides a media, which can be a tag, displayed image, associated sheet or other media, carry a CCCP symbol. It is understood that the carbon credit producer can be one of the type of carbon reducing systems previously described, i.e., planting of trees, grass, herbaceous plants etc. good or service which recycles carbon emissions, whereas the carbon credit user can be a good or service which through manufacture or use creates an emission of the type including CO₂ or other carbon based harmful emission.

The carbon credit software 18 enables creation of a client account in the memory 16 for maintaining carbon credits in the account. The carbon credit software 18 enables a client accessing the carbon credit software 18 to purchase or sell a carbon credit or to list one of an offer to sell a carbon credit producer or carbon credit user. The carbon credit software 18 initiates a carbon reduction/recycling process as a result of the purchase, e.g., the planting of a tree. The purchase also causes a product or service item bearing the CCCP symbol to be sent to the purchaser, e.g., a T-shirt bearing the CCCP symbol.

Further, products or services bearing the CCCP symbol which are sold in the economy external to the system 10 can be registered in database 20 on the memory 16 via the carbon credit software 18 using a product or service code, e.g., a serial number. Upon purchase of such CCCP bearing item, a consumer can access the web site and the client's account and using the carbon credit software 18 and enter the code of the product/service and be credited a number of carbon credits to his/her account. These credits can be subsequently used for any variety of purchase or trading transactions.

An example of how this works is as follows. A consumer has the option to purchase one of two cellular telephones. One phone has the CCCP stamp indicating the manufacturer has purchased Rainforest carbon credits covering any environmental damage that may have been caused in the production of their cell phone. The consumer equates that to being environmentally responsible and elects to purchase the cell phone with the “green CCCP” label. Let's say the phone has 10 CCCP points. The consumer can then log onto the system 10 and via the web site enter the code provided on the cell phone, be credited the Rainforest carbon credits and use these credits to purchase various other items which exist available at the web site, for example, in similar way one might use mileage points to get a discount on an airline ticket.

The carbon credit software 18 enables access of multiple clients, each client has a carbon credit account. The carbon credit software enables a trade of carbon credits between the clients. The carbon credit software provides for securely creating and accessing the client account, i.e., a login page is provided for the user.

The above described embodiments are set forth by way of example and are not for the purpose of limiting the present invention. It will be readily apparent to those skilled in the art that obvious modifications, derivations and variations can be made to the embodiments without departing from the scope of the invention. Accordingly, the claims appended hereto should be read in their full scope including any such modifications, derivations and variations.

1. A carbon credit system, comprising:
a server computer operably connected to an Internet and having an operating system and a memory operably associated therewith, carbon credit software operably disposed in said memory and accessible through said operating system, wherein a carbon credit product or carbon credit service can be purchased through said carbon credit software and which carries a predetermined number of carbon credits and said purchase causes one of a good and service certificate bearing a carbon credit consumer symbol (“CCCP”) to be sent to said purchaser.

2. The carbon credit system of claim 1, wherein said carbon credit software enables creation of a client account in said memory and for maintaining carbon credits in said account wherein said carbon credit software enables associating and storing said carbon credits with at least one of a carbon credit producer and carbon credit user in a database in said memory.

3. The carbon credit system of claim 1, wherein said carbon credit software enables a client accessing said carbon credit software to purchase a carbon credit.

4. The carbon credit system of claim 1, wherein said carbon credit software enables a client accessing said carbon credit software to sell a carbon credit.

5. The carbon credit system of claim 1, wherein said carbon credit software enables a client accessing said carbon credit software to list one of an offer to sell said carbon credit producer and an offer to purchase said carbon credit user.

6. The carbon credit system of claim 1, wherein said carbon credit software initiates a carbon reduction process as a result of said purchase.

7. The carbon credit system of claim 1, wherein said carbon credit software enables access of multiple clients, each said client having a carbon credit account.

8. The carbon credit system of claim 7, wherein said carbon credit software enables a trade of carbon credits between said clients.

9. The carbon credit system of claim 1, wherein said carbon credit software provides for securely creating and accessing said client account.

10. The carbon credit system of claim 1, wherein said carbon credit software includes means for determining a number of carbon credits for one of a predetermined good and a predetermined service as a function of carbon emitted by said good and service.

11. A carbon credit system, comprising:
a server computer operably connected to an Internet and having an operating system and a memory operably associated therewith, carbon credit software operably disposed in said memory and accessible through said operating system, said carbon credit software enables creation of a client account in said memory and for maintaining carbon credits in said account wherein said carbon credit software enables associating purchased carbon credits and storing said carbon credits in said account, wherein a carbon credit consumer symbol (“CCCP”) bearing product or carbon credit consumer symbol (“CCCP”) bearing service can be registered in a database with a predetermined product or service specific code, where upon a purchase of said product or service occurring external to said carbon credit software, said carbon credit software permits a purchaser to enter said code and be credited a predetermined amount of carbon credits associated with said purchased good or service.

12. The carbon credit system of claim 11, wherein said carbon credit software causes one of a good and service certificate bearing a carbon credit consumer symbol (“CCCP”) to be sent to said purchaser upon entering said code.

13. The carbon credit system of claim 11, wherein said carbon credit software enables a client accessing said carbon credit software to purchase a carbon credit.

14. The carbon credit system of claim 11, wherein said carbon credit software enables a client accessing said carbon credit software to sell a carbon credit.

15. The carbon credit system of claim 11, wherein said carbon credit software enables a client accessing said carbon credit software to list one of an offer to sell said carbon credit producer and an offer to purchase said carbon credit user.

16. The carbon credit system of claim 11, wherein said carbon credit software initiates a carbon reduction process as a result of said purchase.

17. The carbon credit system of claim 11, wherein said carbon credit software enables access of multiple clients, each said client having a carbon credit account.

18. The carbon credit system of claim 17, wherein said carbon credit software enables a trade of carbon credits between said clients.

19. The carbon credit system of claim 11, wherein said carbon credit software provides for securely creating and accessing said client account.

20. The carbon credit system of claim 11, wherein said carbon credit software includes means for determining a number of carbon credits for one of a predetermined good and a predetermined service as a function of carbon emitted by said good and service.

21. A method of promoting carbon reduction, which includes the steps of:
(a) associating a carbon credit consumer symbol (“CCCP”) with a product or service, and
(b) initiating a natural reforestation process in response to said step of associating said carbon credit.

22. The method of claim 21, wherein said natural reforestation includes the steps of
(c) planting a tree,
(d) allowing said tree to grow for a predetermined period of time subsequent to a predetermined carbon absorption capability of said tree,
(e) harvesting said tree, and
(e) repeating said steps c-e.
